(19) United States
(12) Patent Application Publication
(10) Pub. No.: US 2012/0110067 A1
(43) Pub. Date: May 3, 2012

(54) REMOTE GRAPHICS RENDERING

(76) Inventors: Luka Birsa, Ljubljana (SI); Matej Zalar, Ljubljana (SI); Rok Zalar, Ljubljana (SI)

(21) Appl. No.: 13/283,581

(22) Filed: Oct. 28, 2011

Related U.S. Application Data
(60) Provisional application No. 61/408,416, filed on Oct. 29, 2010.

(51) Int. Cl. G06F 15/16

(52) U.S. Cl. 709/203

(57) ABSTRACT

An example method for remote graphics rendering may comprise receiving a data request from the client device to display data stored in a remote web server. The data to be displayed may at least partially comprise graphics data. The method may further comprise determining whether or not the client device is associated with a client entity. The client entity can be assigned to the client device to maintain one or more of a client browsing session and a client browser environment. Based on the determination, the client device can be selectively associated with the client entity. The method may further comprise retrieving response data from the remote web server in response to the data request. The response data may comprise the graphics data. The method may further comprise optimizing the graphics data to produce optimized graphics data and sending the optimized graphics data to the client device.

### CROSS-REFERENCE TO RELATED APPLICATIONS

This application claims priority of U.S. Provisional Application No. 61/408,416, entitled “SYSTEMS AND METHODS FOR REMOTE GRAPHICS RENDERING ON A DEVICE,” filed Oct. 29, 2010, which is incorporated herein by reference in its entirety for all purposes.

### TECHNICAL FIELD

This disclosure relates generally to remote data processing, and more specifically, to systems and methods for remote graphics rendering on a client device that is communicatively coupled to a server via a network.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

From 1950 to 1980, computing power was reasonably expensive. Therefore, owners of mainframe computers could share and sell that computing power to other users by providing terminal access via Plain Old Telephone System (POTS) modems or other networking systems available at the time. These users could use terminals to access the mainframe computers and run their applications remotely. Data was exchanged between a terminal (the client) and a mainframe computer (the server) in a stream of characters and displayed on the terminal screen. Since then, terminal access faded from popularity due to the increased performance of microcontrollers and processors allowing personal or enterprise users to afford their own computers.

The rise of the Network Computer (NC) paradigm occurred from 1980 to 2000 and was championed by industry heavy weights (e.g., IBM® and ORACLE®). Instead of the character-based terminal systems of the previous years, network computers were able to provide graphics access to applications run on a centralized server. The server could run an application and transmit the graphics viewport of the application to a network computer. A network computer was a simplified device (compared to a stand-alone computer), often consisting of a graphics display and input devices (e.g., mouse and keyboard). At the height of its popularity, it was envisioned that users would use Network Computers (NCs) to connect to centralized resources, and that the need for expensive personal computing would eventually disappear.

This never happened because the processing power of computer hardware has been rapidly decreasing in price. According to Moore's law, the same amount of money can buy twice as much processing power every 18 months. Accordingly, systems supporting complex graphics interfaces have become very inexpensive, while at the same time the graphics operating systems have increased their capabilities in order to provide users with an enjoyable experience (most notably Microsoft® with its Windows® software). NCs faded from the industry use, except for some presence in larger enterprise or public sectors where computer management presents a serious issue.

Recently, the centralized computing paradigm has seen a return, although it is now in the form of the cloud computing. One of the reasons for its return is the need for centralizing and managing vast amounts of data (rather than the cost of hardware or software, since both have become very affordable). Additionally, we have experienced an incredible surge in the usage of the Internet as a medium. Personal and enterprise users have been using the Internet daily for work, entertainment, and communication with people across the world. As the Internet progressed, it became obvious that users are converging on a few selected services, most notably the World Wide Web, which is primarily accessed through web browser software (e.g., Internet Explorer® and Mozilla Firefox®).

This convergence caused a paradigm shift in software development where developers have been moving their software from the end users' computers to Internet connected servers, thereby providing the users with access to the software via web browsers. Thus, instead of developing a desktop application to run on a user's computer, the industry has been developing web-based applications to run on remote web servers, which can be accessed through the Internet.

Typically, users may connect to the Internet with a wide variety of devices in addition to their Personal Computers (PCs). The array of devices spans from Personal Digital Assistants (PDAs), notebooks, mobile tablet PCs, cellular telephones, smart phones, to even simpler web-enabled devices. All of these portable electronic devices have varying processing power and battery storage capabilities, which might be limiting their ability to achieve the PC-like experience while using a web browser. Personal computing devices are ubiquitous now and users tend to move from one device to another quite often. However, as a user switches devices, he or she has to adapt to a new browsing environment, which may be inconvenient for most users.

The foregoing issues are only partially addressed by solutions currently present on the market. Thus, a system for accessing a web browser on even the most basic of portable electronic devices is still lacking. Furthermore, there is no system that enables seamless transitions from one device to another for the user of the system. Therefore, there is no current network graphics rendering system for remote devices.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with various embodiments and the corresponding disclosure thereof, a computer-implemented method for remote graphics rendering on a client device is provided. The method may comprise receiving from the client device a data request to display data stored in a remote web server. The data to be displayed may at least partly comprise graphics data. The method may further comprise determining whether or not the client device is associated with a client entity. The client entity can be assigned to the client device to maintain one or more of a client browsing session and a client browser environment. Based on the determination, the client device can be selectively associated with the client entity. The method may further comprise retrieving, via browser session and/or client browser environment, from the remote web server, response data in response to the data request. The response data may comprise the graphics data. The method may further comprise optimizing the graphics data to produce optimized graphics data and sending the optimized graphics data to the client device.

The optimized graphics data is to be used to render graphics and display the graphics on a display of the client device according to the client browsing session and/or the client browsing environment. The data request can be received over a network, to which the client device is communicatively coupled. The method may further comprise caching the data request and optimized graphics data associated with the data request. The method may further comprise determining whether or not a substantially similar data request has been previously processed. The method may also check whether or not a substantially similar data request was previously processed to generate optimized graphics data. A positive determination enables utilizing cached optimized graphics associated with the similar data request, but in cases of a negative determination, the data request is selectively communicated to the remote web server.

In various example embodiments, the optimizing of the graphics data may comprise one or more of data converting, data compressing, data encoding, and changing data format. The retrieving of the response data from the remote web server may comprise selectively communicating the data request to the remote web server over a network.

According to various embodiments disclosed herein, a computer-implemented system for remote graphics rendering on a client device is disclosed. The system may comprise a network connectivity component configured to receive, from the client device, a data request to display data stored in a remote web server and a routing component configured to determine whether or not the client device is associated with a client entity. Based on the determination, the routing component will selectively associate the client device with the client entity. The system may further comprise a web browser component to retrieve, in response to the data request, from the remote web server, response data. The response data may comprise the graphics data, an optimizing component configured to optimize the graphics data to produce optimized graphics data. The network connectivity component may be further configured to send the optimized graphics data to the client device.

According to various embodiments disclosed herein, a client device for graphics rendering is provided. The client device may comprise an interaction component configured to detect user interaction with the client device and, responsive to the user interaction, generate data request to display data stored in a remote web server, where the data to be displayed at least partly comprises graphics data. The data request, in turn, can be processed as described herein with respect to the method for remote graphics rendering. The client device may further comprise a network connectivity component configured to send the data request to a system for remote graphics rendering and receive optimized graphics data in response to the data request, and a display component configured to render the optimized graphics data.

According to yet more embodiments disclosed herein, a machine-readable medium is provided. The machine-readable medium comprises instructions, which when implemented by one or more processors cause the one or more processors to perform the method for remote graphics rendering on a client device as described herein.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a client-server environment suitable for implementing methods for remote graphics rendering on a client device, according to an example embodiment.

FIG. 2 is a block diagram illustrating a client-server environment suitable for implementing methods for remote graphics rendering on a client device, according to another example embodiment.

FIG. 3 is a detailed block diagram of a network graphics rendering system, according to an example embodiment.

FIG. 4 is a flow chart of a workflow illustrating the operation of a client device and a client entity running on a network graphics rendering system, according to an example embodiment.

FIG. 5 is a block diagram illustrating a client-server environment suitable for implementing methods for a remote graphics rendering system, according to another example embodiment.

FIG. 6 is a block diagram illustrating an example client-server environment suitable for implementing the network graphics rendering system, which may be used to enable utilization of a plurality of devices by a single user.

FIG. 7 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein might be implemented using a variety of technologies. For example, the methods described herein may be implemented in software executing on a computer system, or implemented in hardware utilizing a combination of microprocessors or other specially designed application-specific integrated circuits (ASICs), programmable logic devices, or various combinations thereof. In particular, the methods described herein may be implemented by a series of computer-executable instructions residing on a storage medium such as a carrier wave, disk drive, or computer-readable medium. Exemplary forms of carrier waves may take the form of electrical, electromagnetic, or optical signals conveying digital data streams along a local network or a publicly accessible network such as the Internet.

The embodiments described herein relate to computer-implemented methods and systems for remote graphics rendering in a client-server environment. An architecture within which the systems and methods for remote graphics rendering are implemented may include, among other components, a web server running server instants and web client software installed in a client device. The server instance may perform, among other things, tasks that are ordinarily performed by a conventional web browser. The server instance may send optimized graphics data to the web client software running on the client device. Furthermore, the web client software may render the graphics on the device's display. The client device may include a PC, a network computer, a laptop, a tablet computer, a cellular telephone, a smart phone, a PDA, or any other computing device with ability to interact with a remote web server over a network such as the Internet.

The architecture may allow for transferring requests to process and prepare for the rendering of web data from the client device to the server instance. The server instance may maintain dedicated client web browsing sessions (and/or client browser environments) to support the web client software for a specific client device. Thus, systems and methods for remote graphics rendering on a client device may eliminate the need for high computing performance of the client device since all or most of the processing related to running the application and preparing the graphics for rendition is performed on the server instance running within the web server.

The systems and methods for remote graphics rendering on a client device may make it possible to equip the client device with the web browsing capability as long as the client device is capable of displaying graphics information and has network connectivity. This approach may enable vast application functionality on a wide variety of simpler devices like thin clients, normally incapable of supporting a standard web browser.

Furthermore, the systems and methods for remote graphics rendering on a client device may enable a user to move seamlessly between different client computing devices while supported by the same server instance maintaining the same web browser sessions. In contrast, conventional web architecture relies on a device-specific web browser instance to process the data related to a web browser session.

The following description provides the detailed description of various embodiments related to the systems and methods for remote graphics rendering in client-server environment.

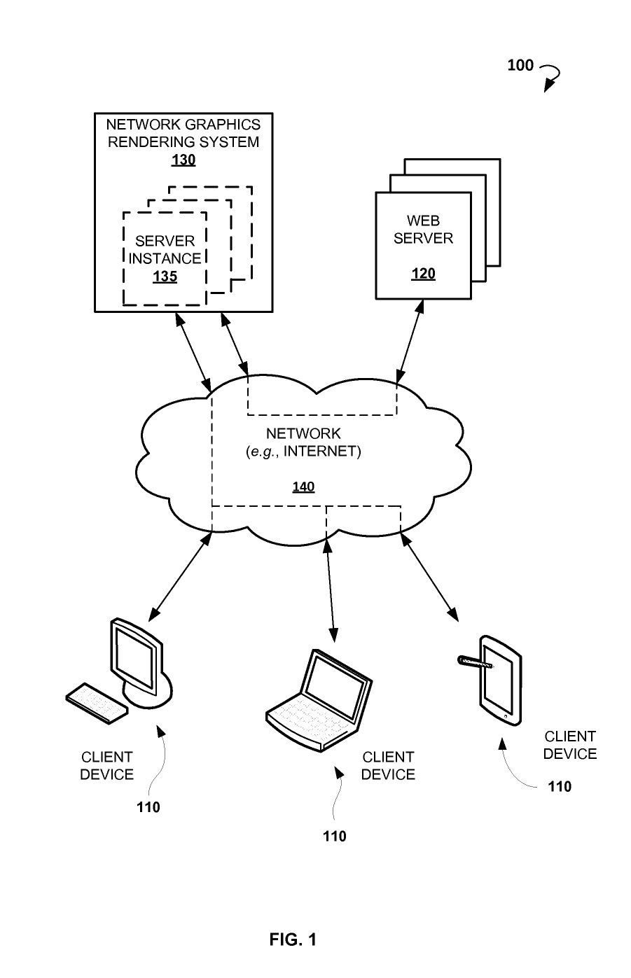

Referring now to the drawings, FIG. 1 shows a block diagram illustrating a client-server environment 100 suitable for implementing methods for remote graphics rendering on a client device, according to an example embodiment. The client-server environment 100 comprises one or more client devices 110, one or more web servers 120, a network graphics rendering system 130, and a network 140, which may communicatively couple all aforementioned devices and systems.

The network 140 is a network of data processing nodes interconnected for the purpose of data communication. The network 140 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 140 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The client device 110 may refer to a computer, a laptop, a tablet computer, a portable computing device, a PDA, a handheld cellular phone, a mobile phone, a smart phone, a thin client, or any other electronic computing device suitable for communicating data via the network 140. The client devices 110 may be configured to communicate with the network graphics rendering system 130, generate and send data requests to network graphics rendering system 130 to process and prepare for rendering graphics data, receive optimized graphics data, render and display graphics data, and so forth. In some embodiments, the client devices 110 may embed within a dedicated application or software (e.g., client software providing the ability to communicate with the network graphics rendering system 130).

The web server 120 may refer to hardware, software, or a combination thereof dedicated to host one or more web sites or store data, including graphics data, which can be accessed and downloaded via the network 140. In some examples, the client devices 110 cannot access the web servers 120 directly or can be limited in computing resources to render the graphics that can be provided by the web servers 120. Accordingly, the web server 120 may be accessed by the network graphics rendering system 130, which may serve as an “intermediate means” between the client devices 110 and the web server 120 and be used to process data retrieved from the web servers 120 for further rendering and displaying on the client devices 110.

The network graphics rendering system 130 can be implemented as a remote web server, which may perform, among other things, any tasks to deliver content to the one or more client devices 110 that can be accessed through the network 130. The network graphics rendering system 130 may embed one or more server instances 135 to support the web client software installed within the one or more client devices 110.

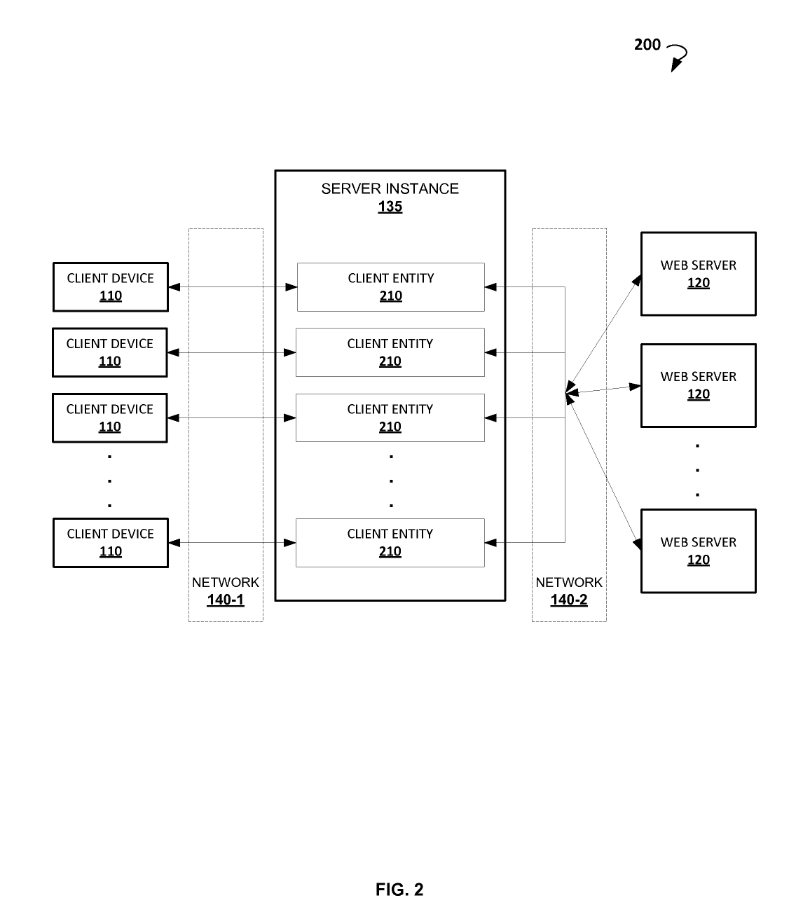

FIG. 2 is a block diagram illustrating a client-server environment 200 suitable for implementing methods for remote graphics rendering on a client device, according to another example embodiment. As shown in the figure, the client-server environment 200 comprises the one or more client devices 110, the one or more web servers 120, and the server instance 135, which can run on the network graphics rendering system 130.

The one or more client devices 110 can be communicatively coupled to the server instance 135 via a network 140-1. Similarly, the one or more web servers 120 can be communicatively coupled to the server instance 135 via a network 140-2. The networks 140-1 and 140-2 can be different examples of the network 140 discussed above. However, in some other examples, the networks 140-1 and 140-2 can be the same network 140 (e.g. the Internet). Moreover, in some embodiments, the web server 120 can be integrated within the server instance 135.

The server instance 135 may host one or more of client entities 210. Each client entity 210 can be configured to provide relevant processes for a specific client device 110. Accordingly, any data requested by a specific client device 110 from a specific web server 120 can be processed in the corresponding client entity 210 to render optimized graphics data for further displaying via the client device 110 that generated the corresponding data request. Each client entity 210 can be considered as one or more threads or software processes.

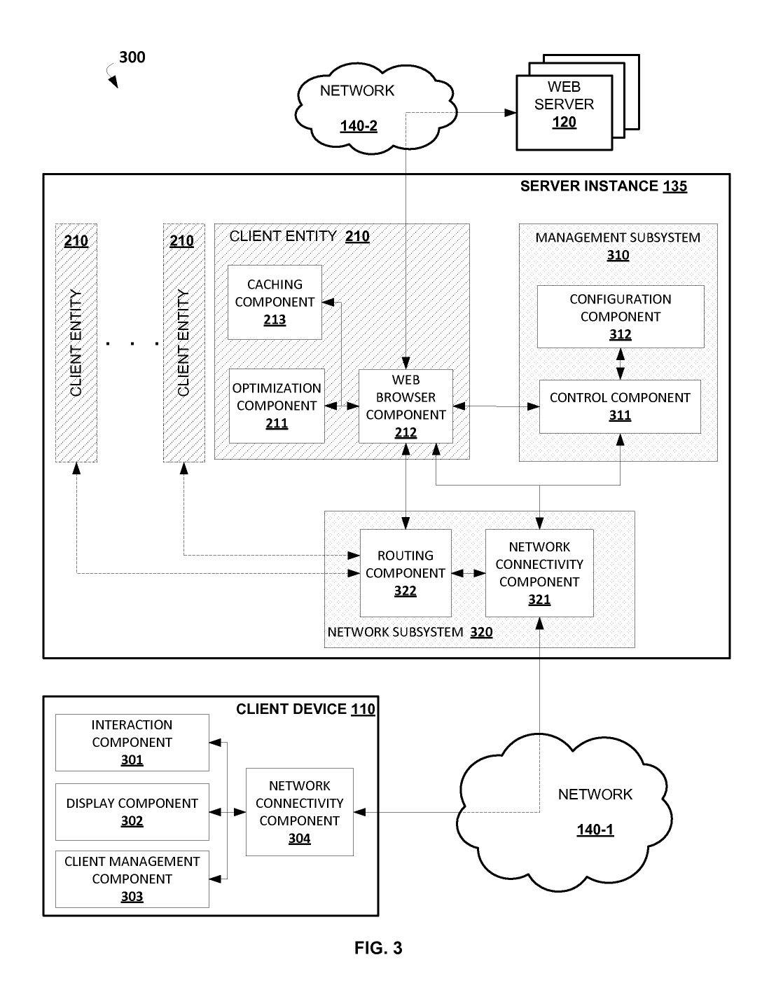

FIG. 3 is a more detailed block diagram of a network graphics rendering system 300, according to an example embodiment. As shown in FIG. 3, the client device 110 may include an interaction component 301, a display component 302, a client management component 303, and a network connectivity component 304.

The interaction component 301 can be configured to detect user interaction such as a touch, click, swipe, gesture, shake, and so forth, and obtain user input. Based on the detected user interaction, different data requests can be generated. The data requests may comprise instructions to retrieve certain data (including graphics data) from a certain remote web server 120. The display component 302 can be configured to display graphics data delivered via the network 140-1 from the server instance 135 on a display screen of the client device 110. The client management component 303 can be configured to track the operations and events occurring at the client device 110 which are not deliberately caused by the user (such as, for example, power indications, network signal or network quality indications, events related to entering and leaving a network coverage area, and other control events). The network connectivity component 304 can be configured to provide the client device 110 with means for connecting via the network 140-1 to the server instance 135.

The server instance 135 may include the one or more client entities 210, a management subsystem 310, and a network subsystem 320. The management subsystem 310 may include a control component 311 and a configuration component 312. The control component 311 can be configured to track events and statistics associated with the management subsystem 310 as well as to allow or deny access to the server instance 135 by the client entities 210. The configuration component 312 can be configured to facilitate or implement configuration and/or reconfiguration of the server instance 135, including configuration and/or reconfiguration of the client entities 210.

The networking subsystem 320 can be configured to provide network connectivity capabilities to the server instance 135. More specifically, the network subsystem 320 may include a network connectivity component 321 and a routing component 322. The server instance 135 may use the network connectivity component 321 to receive data requests from the one or more client devices 110. The data request received by the network connectivity component 321 can be forwarded by the routing component 322 to the appropriate client entity 210. Accordingly, the routing component 322 can be configured to determine whether a certain client device 110 is associated with a corresponding client entity 210, and based on the determination, selectively associate the client device 110 with the corresponding client entity 210.

The client entity 210 may be assigned to the client device 110 in order to maintain one or more of a client browsing session and a client browser environment. The client entity 210 may include an optimization component 211, a web browser component 212, and a caching component 213. Once the routing component 322 has selected the appropriate client entity 210, it may forward the data request from the client device 110 to the web browser component 212. The web browser component 212 may perform the interaction in an embedded web browser, which may result in a graphics output of the embedded web browser. This may be similar to how users interact with their own desktop web browser software in a conventional system. To be more specific, each user data request may cause their web browser to perform a certain task whose results are displayed on the display screen of the client device 110. According to one example embodiment, the browser may be running embedded in the client entity 210 and perform actions without direct output of the resulting graphics. Instead, the resulting graphics may be optimized for transmission by the optimization component 211 and cached by the caching component 213.

The optimized graphics may be sent to the network connectivity component 321 of the network subsystem 320, which may, in turn, send the optimized graphics to the client device 110. The optimized graphics may be received by the network connectivity component 304 of the client device 110 and displayed by the display component 302. The web browser component 212 of the client entity 210 may connect to one or more web servers 120 via the network 140-2 in order to perform regular web browser tasks.

Accordingly, when a user generates a request to display a certain web site including graphics data on its client device 110, the request is received and processed by the server instance 135 such that a certain client entity 210 retrieves requested data from a corresponding web server 120, optimizes obtained graphics data (depending on predetermined settings) to obtain optimized graphics data, and sends this optimized graphics data to the client device 110 for further displaying on its screen. For this end, the client device 110 may embed web client software (e.g., an ad hoc application to make requests and display obtain graphics data). Thus, the client device 110 does not need to have high productivity and computational capabilities to render and display complex and heavy graphics data, as it can be preliminary optimized in the remotely located server instance 135.

In addition, upon receipt of a data request, the web browser component 212 may also determine whether a substantially similar data request has been previously processed in the server instance 135. The positive determination may enable the utilization of cached optimized graphics associated with the similar data request for further delivering to the client device 110. Otherwise, the web browser component 212 may selectively communicate the data request to the corresponding web server 120.

The networks 140-1 and 140-2 can be different examples of the network 140 discussed above and be independent of each other. However, in some embodiments, the networks 140-1 and 140-2 can be the same network 140 (e.g. the Internet).

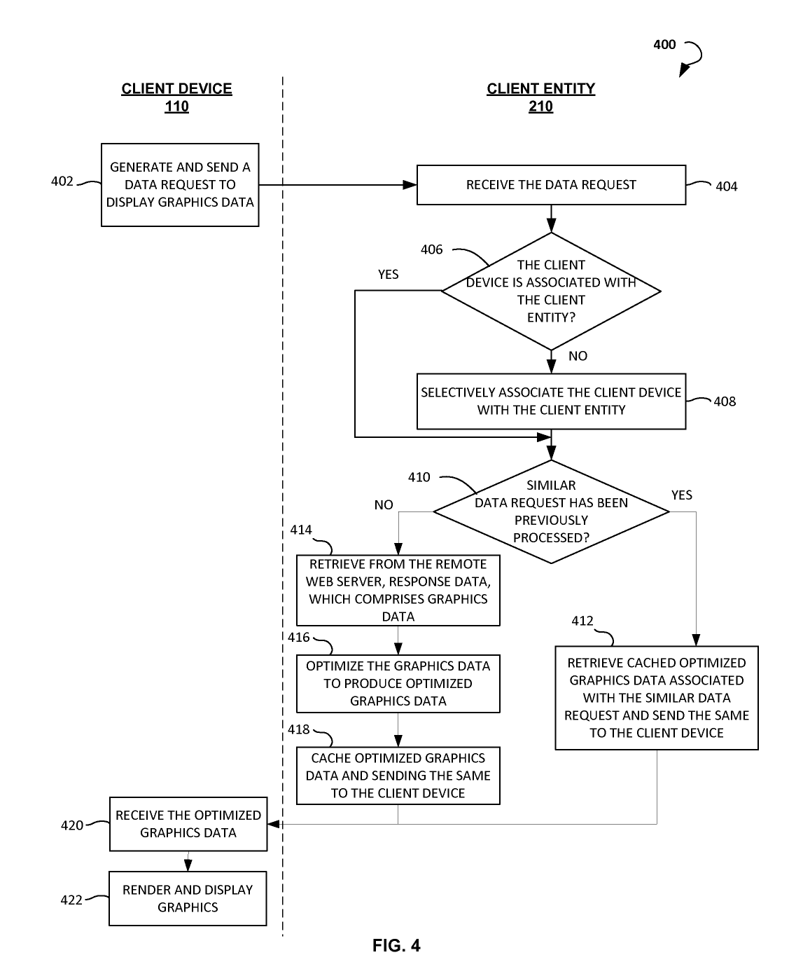

FIG. 4 is a flow chart of a method 400 illustrating operation of the client device 110 and the client entity 210 running on the network graphics rendering system 135, according to an example embodiment. The method 400 may be performed by processing logic that may comprise hardware (e.g., dedicated logic, programmable logic, and microcode), software (such as software run on a general-purpose computer system or a dedicated machine), or a combination of both.

The method 400 can be performed by various components discussed above with reference to FIG. 3. Each of these components can comprise processing logic. It will be appreciated by one of ordinary skill that examples of the foregoing components may be virtual, and instructions said to be executed by a component may, in fact, be retrieved and executed by a processor. The foregoing components may also include memory cards, servers, and/or computer disks. Although various components may be configured to perform some or all of the various steps described herein, fewer or more components may be provided and still fall within the scope of various embodiments.

As shown in FIG. 4, the method 400 may commence at operation 402 with the client device 110 generating a data request to display data on the screen display of the client device 110 and sending the same to the client entity 210 allocated to the client device 110 and running on the server instance 135. The data request can be generated through user interaction with the client device 110 as detected by the interaction component 301. The user interaction may include touching, clicking, swiping, shaking, gesturing or any other type of tactile and/or touch-less interactions, which can be communicated from the interaction component 301 to the client entity 210 through the network connectivity components 304 and 321.

At operation 404, the client entity 210, and more specifically the routing component 322, may receive the data request from the client device 110. At operation 406, the routing component 322 may determine whether the client device 110 is associated with a corresponding client entity 210. The client entity 210 should be assigned to the client device 110 to maintain one or more of a client browsing session and a client browser environment. If it is determined that the client device is not associated with any client entity 210, at operation 408, the routing component 322 may selectively associate the client device 110 with the corresponding client entity 210. Accordingly, when the client entity 210 is assigned, the data request is transmitted to the web browser component 212 related to the assigned client entity 210.

At operation 410, the web browser component 212 may determine whether the same (or similar) data request has been already received and processed so that the caching component 213 of the client entity 210 has cached the results of that previous interaction. Local caching may allow for storing optimized results of previous interactions, which are sent out to the client device 110 if client entity 210 determines at operation 410 that the optimized result of an interaction is already stored in the caching component 213.

Thus, if it is determined at operation 410 that the results are already cached by the caching component 213, at operation 412, the results of the optimization are retrieved from caching component 213 and sent directly to the client device 110 without additional processing and optimization.

If, on the other hand, it is determined at operation 410 that the results are not cached, the method 400 proceeds to operation 414 when the web browser component 212 may retrieve, in response to the data request, the requested data from a certain remote web server 120. The data retrieved from the remote web server 120 may comprise graphics data.

At the following operation 416, the optimization component 211 of the client entity 210 may optimize the graphics data retrieved from the remote web server 120 to produce optimized graphics data, and may send the same to the client device 110. In particular, the rendered graphics data may be optimized in terms of the amount of data to be sent from the client entity 210 to the client device 110 after data converting, data compression, data encoding, and/or changing data format.

At operation 418, the caching component 213 may store the optimized graphics data in association with the data request, and the web browser component 212 may send the optimized graphics data to the client device 110 via the network 140. At operation 420, the optimized graphics data is received by the client device 110, and, at operation 422, the display component 302 may render and display the optimized graphics data on the display screen of the client device 110.

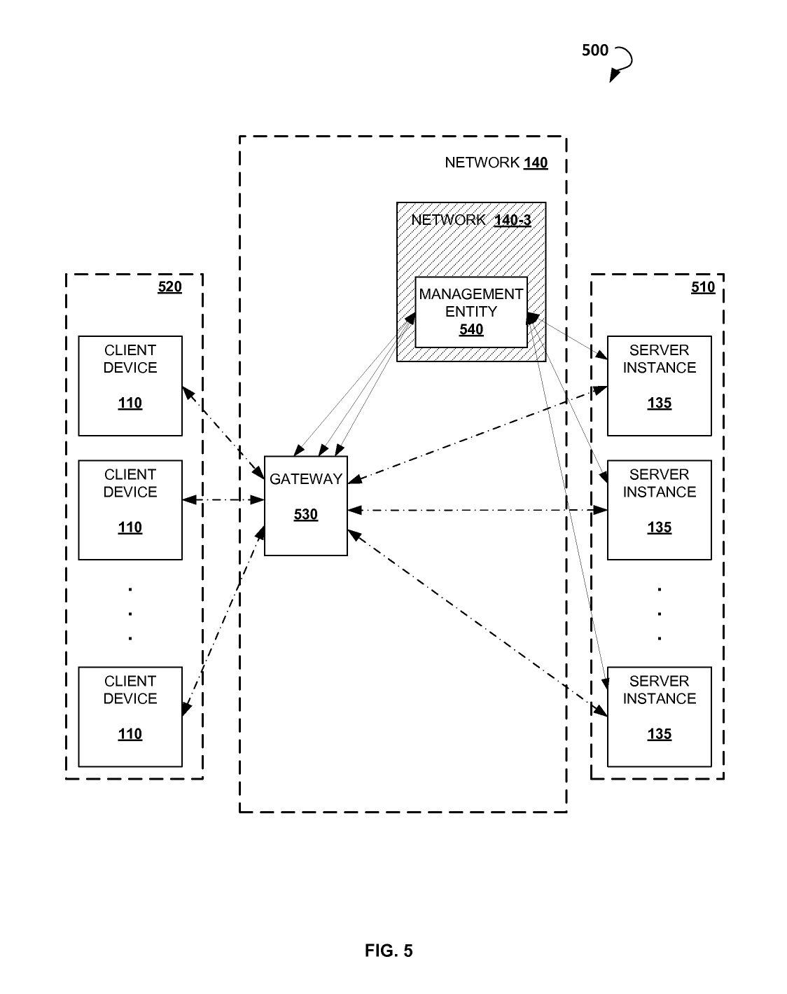

FIG. 5 is a block diagram illustrating a client-server environment 500 suitable for implementing methods for remote graphics rendering, according to another example embodiment. As shown in the figure, the environment 500 may employ a plurality of server instances 510 to serve a plurality of client devices 520. Each client device 110 may be connected to a single server instance 135 via a gateway 530 shown within the context of the network 140. The gateway 530 may, in various embodiments, comprise hardware, software, or a combination thereof. The gateway 530 may direct data from any number of client devices 110 to the appropriate server instances 135. Although only one gateway 530 is shown, those with ordinary skill in the art will appreciate that multiple gateways 530 can be utilized.

A management entity 540 may logically connect, via a network 140-3, each of the server instances 135 to each of the gateways 530. The network 140-3 can be a part of the network 140, be the same as the network 140, or be different from the network 140 but still be an example of the network 140 as described above.

The management entity 540 may manage and control the operations of each server instance 135 and the gateways 530. The management tasks performed by the management entity 540 may include determining on which server instance 135 a new client entity 210 is to be spawned, adding a new server instance 135 (or a gateway 530) to the plurality of server instances 510 (or gateways 530), determining whether a certain client device 110 is allowed to connect to the network 140, managing configuration settings of each server instance 135 and each gateway 530, tracking the amount of client entities 210 each of the server instances 135, and other various management and control tasks.

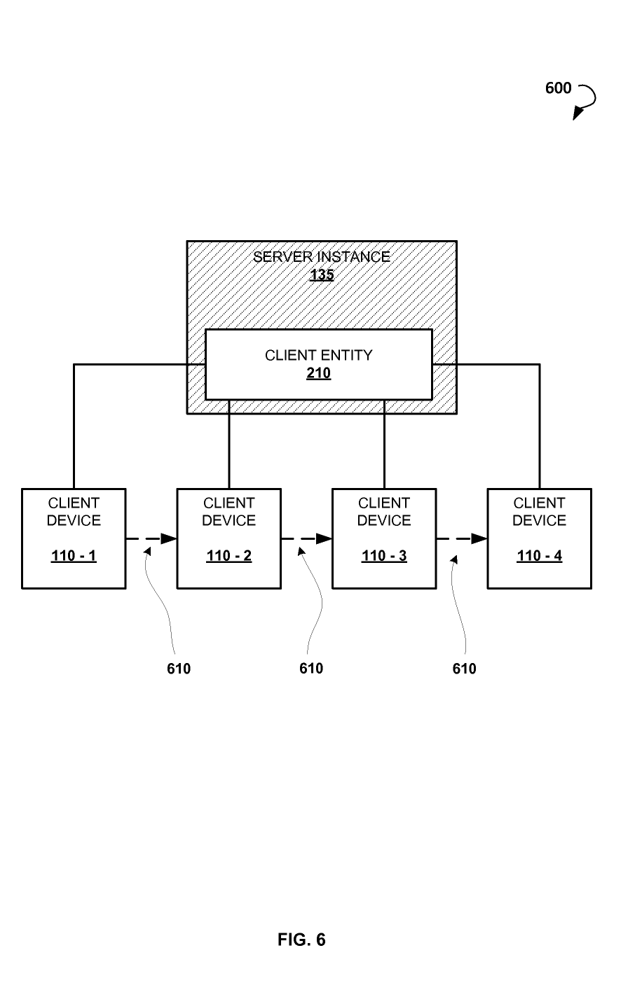

FIG. 6 is a block diagram illustrating an example client-server environment 600 suitable for implementing the network graphics rendering system, which may be used to enable utilization of a plurality of devices by a single user. As is shown in FIG. 6, the implementation of the network graphics rendering system 130 may allow a plurality of client devices 110-1, 110-2, 110-3, and 110-4 to consecutively connect to the single client entity 210 running within the server instance 135. Specifically, a user using the client device 110-1 (e.g., a thin client, a PC, etc.) may transition to another client device via a transition 610 and start using a client device 110-2 (e.g., a mobile telephone). The server instance 135 may be capable of reconfiguring the user's single client entity 210 so that the user's transitions 610 between client devices 110-1, 110-2, 110-3, and 110-4 are seamless from the user's point of view. User may be able to transition between any number of client devices in any order. Although four client devices 110-1, 110-2, 110-3, and 110-4 are shown, there could be any number of client devices, as should be readily understood by those skilled in the art.

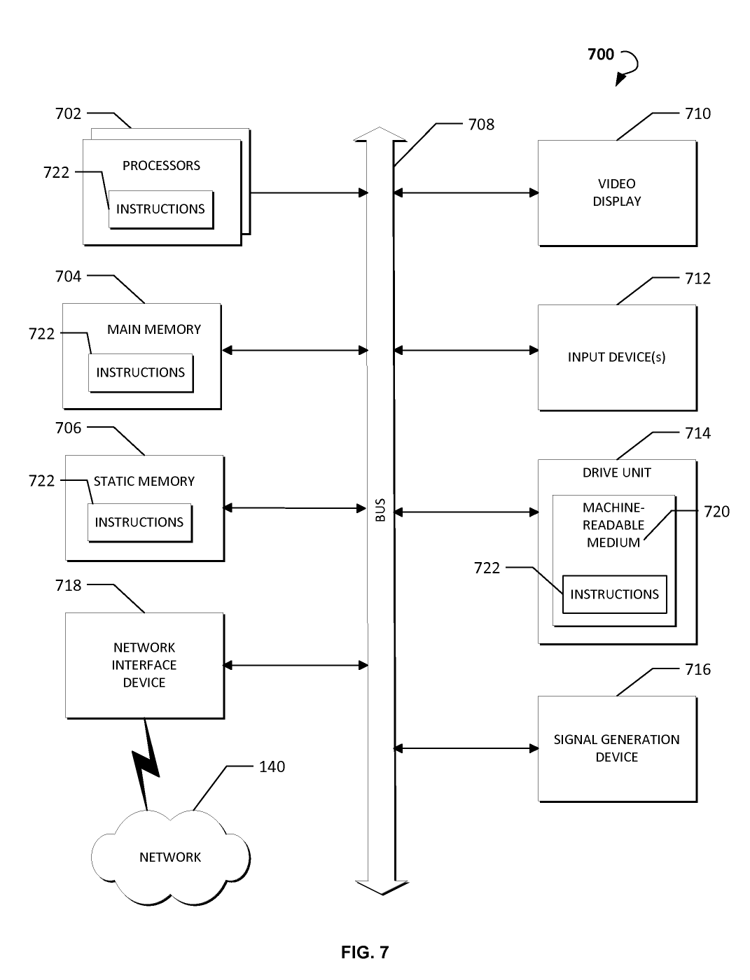

FIG. 7 shows a diagrammatic representation of a computing device for a machine in the example electronic form of a computer system 700, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), and a main memory 704 and a static memory 706, which communicate with each other via a bus 708. The computer system 700 can further include a video display unit 710 (e.g., a liquid crystal display (LCD) or a cathode ray tube (CRT)). The computer system 700 also includes at least one input device 712, such as an alphanumeric input device (e.g., a keyboard), a cursor control device (e.g., a mouse), a microphone, a digital camera, a video camera, and so forth. The computer system 700 also includes a disk drive unit 714, a signal generation device 716 (e.g., a speaker), and a network interface device 718.

The disk drive unit 714 includes a computer-readable medium 720 that stores one or more sets of instructions and data structures (e.g., instructions 722) embodying or utilized by any one or more of the methodologies or functions described herein. The instructions 722 can also reside, completely or at least partially, within the main memory 704 and/or within the processors 702 during execution thereof by the computer system 700. The main memory 704 and the processors 702 also constitute machine-readable media.

The instructions 722 can further be transmitted or received over the network 140 via the network interface device 718 utilizing any one of a number of well-known transfer protocols (e.g., Hyper Text Transfer Protocol (HTTP), CAN, Serial, and Modbus).

While the computer-readable medium 720 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, Perl, UNIX Shell, Visual Basic or Visual Basic Script, Virtual Reality Markup Language (VRML), ColdFusion™ or other compilers, assemblers, interpreters or other computer languages or platforms.

Accordingly, the example embodiments described herein may be implemented in an operating environment comprising software installed on a machine, in hardware, or in a combination of software and hardware.

Thus, systems and methods for remote graphics rendering in client-server environment have been described. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What is claimed is:

1. A computer-implemented method for remote graphics rendering on a client device, the method comprising:
receiving from the client device a data request to display data stored in a remote web server, the data to be displayed at least partially comprising graphics data;
determining whether the client device is associated with a client entity, the client entity being assigned to the client device to maintain one or more of a client browsing session and a client browser environment;
based on the determination, selectively associating the client device with the client entity;
retrieving, from the remote web server, response data in response to the data request, the response data comprising the graphics data;
optimizing the graphics data to produce optimized graphics data; and
sending the optimized graphics data to the client device.

2. The method of claim 1, wherein the optimized graphics data is to be used to render and display the graphics on a display of the client device according to the client browsing session and/or the client browsing environment.

3. The method of claim 1, wherein the data request is received over a network, to which the client device is communicatively coupled.

4. The method of claim 1, further comprising caching the data request and optimized graphics data associated with the data request.

5. The method of claim 1, further comprising determining whether or not a substantially similar data request has been previously processed;
wherein a positive determination enables utilizing of cached optimized graphics associated with the similar data request; and
wherein in case of the negative determination, selectively communicating the data request to the remote web server.

6. The method of claim 1, wherein the optimizing of the graphics data comprises one or more of data converting, data compressing, data encoding, and changing data format.

7. The method of claim 1, wherein the retrieving response data from the remote web server comprises selectively communicating the data request to the remote web server over the network.

8. A computer-implemented system for remote graphics rendering on a client device, the system comprising:
a network connectivity component configured to receive from the client device a data request to display data stored in a remote web server, the data to be displayed at least partially comprising graphics data;
a routing component configured to determine whether or not the client device is associated with a client entity, the client entity being assigned to the client device to maintain one or more of a client browsing session and a client browser environment, and based on the determination, selectively associating the client device with the client entity;
a web browser component configured to retrieve, from the remote web server, response data in response to the data request, wherein the response data comprises the graphics data;
an optimizing component configured to optimize the graphics data to produce optimized graphics data; and
wherein the network connectivity component is further configured to send the optimized graphics data to the client device.

9. The system of claim 8, wherein the optimized graphics data is to be used to render graphics and display the graphics on a display of the client device according to the client browsing session and/or the client browsing environment.

10. The system of claim 8, wherein the data request is received over a network, which the client device is communicatively coupled to.

11. The system of claim 8, further comprising a caching component configured to cache the data request and optimized graphics data associated with the data request.

12. The system of claim 8, wherein the web browsing component is further configured to determine whether or not a substantially similar data request has been previously processed;
wherein a positive determination enables utilizing cached optimized graphics associated with the similar data request; and
wherein in case of the negative determination, selectively communicating the data request to the remote web server.

13. The system of claim 8, wherein the optimization of the graphics data comprises one or more of data converting, data compressing, data encoding, and changing data format.

14. The system of claim 8, wherein the web browsing component is further configured to selectively communicate the data request to the remote web server over a network.

15. The system of claim 8, further comprising a configuration component configured to configure and/or reconfigure the client entity.

16. A client device for graphics rendering, the client device comprising:
an interaction component configured to detect user interaction with the client device and, responsive to the user interaction, generate a data request to display data stored in a remote web server, the data to be displayed at least partially comprising graphics data;
a network connectivity component configured to send the data request to a system for remote graphics rendering and receive optimized graphics data in response to the data request;
a display component configured to render the optimized graphics data.

17. The client device of claim 16, wherein the display component is further configured to display the rendered graphics data on a screen of the client device.

18. The client device of claim 16, further comprising a client management component configured to track operations and events occurring at the client device, which are not deliberately caused by the user.

19. The client device of claim 16, wherein the user interaction comprises one or more a touch, a click, a swipe, a gesture, a shake, and a user input.

20. A machine-readable medium comprising instructions, which when implemented by one or more processors, cause the one or more processors to perform the following operations:
receive from a client device a data request to display data stored in a remote web server, the data to be displayed at least partially comprising graphics data;
determine whether or not the client device is associated with a client entity, the client entity being assigned to the client device to maintain one or more of a client browsing session and a client browser environment;
based on the determination, selectively associate the client device with the client entity;
retrieving response data from the remote web server in response to the data request, the response data comprising the graphics data;
optimize the graphics data to produce optimized graphics data; and
send the optimized graphics data to the client device.
